(19) United States
(12) Patent Application Publication
(10) Pub. No.: US 2014/0016374 A1
(43) Pub. Date: Jan. 16, 2014

(54) REGULATION CIRCUIT HAVING OUTPUT CABLE COMPENSATION FOR POWER CONVERTERS AND METHOD THEREOF

(71) Applicant: SYSTEM GENERAL CORP., New Taipei City (TW)

(72) Inventors: TA-YUNG YANG, MILPITAS, CA (US); CHOU-SHENG WANG, KEELUNG CITY (TW)

(21) Appl. No.: 13/941,623

(22) Filed: Jul. 15, 2013

Related U.S. Application Data
(60) Provisional application No. 61/671,838, filed on Jul. 16, 2012.

(51) Int. Cl. H02M 3/335

(52) U.S. Cl. CPC H02M 3/33507
USPC 363/21.15

(57) ABSTRACT

A regulation circuit with the output cable compensation is developed for a power converter. It includes an error amplifier for generating a feedback signal in accordance with an output of the power converter. A compensation circuit is coupled to a transformer of the power converter for generating a compensation signal in response to a transformer signal generated by the transformer. The feedback signal is applied to generate a switching signal for switching the transformer and regulating the output of the power converter. The compensation signal is coupled to modulate the feedback signal for compensating a voltage drop of the output cable of the power converter.

### REFERENCE TO RELATED APPLICATION

This application is based on Provisional Application Ser. No. 61/671,838, filed 16 Jul. 2012, currently pending.

### BACKGROUND OF THE INVENTION

1. Field of the Invention

The present invention relates to a power converter, and more particularly, to the regulation circuit of the power converter.

2. Description of Related Art

For an offline power converter, it requires an error amplifier located at the secondary side of the transformer for generating a feedback signal in accordance with the output of the power converter. The feedback signal is utilized to generate a switching signal to switch the transformer and regulate the output of the power converter. FIG. 1 shows a prior art circuit schematic of a power converter. A PWM controller (PWM) 30 generates a switching signal S_{PWM} to switch a transformer 10 via a power transistor 20 in accordance with a feedback signal V_{FB} for regulating the output of the power converter. The transformer 10 has a primary winding N_{P} and a secondary winding N_{S}. The primary winding N_{P} of the transformer 10 is coupled to receive an input voltage V_{IN}. The feedback signal V_{FB} is generated in accordance with the output of the power converter through an opto-coupler 60.

The opto-coupler 60 is controlled by an error amplifier 50. The error amplifier 50 generates a feedback signal V_{F} coupled to control the opto-coupler 60. The error amplifier 50 includes a reference signal V_{R} supplied with a positive input terminal of the error amplifier 50 for regulating the output voltage V_{O1} of the power converter. The output voltage V_{O1} is coupled to a negative input terminal of the error amplifier 50 via a voltage divider developed by resistors 51 and 52. A capacitor 53 is coupled between the negative input terminal of the error amplifier 50 and an output terminal of the error amplifier 50.

The secondary winding N_{S} of the transformer 10 is coupled to an output terminal of the power converter to generate the output voltage V_{O1}. A rectifier 40 is coupled to one terminal of the secondary winding N_{S}. An output capacitor 45 is coupled to the other terminal of the secondary winding N_{S} and the output terminal of the power converter to generate the output voltage V_{O1}. A resister 62 is coupled form the capacitor 45 and the rectifier 40 to the opto-coupler 60.

Normally, the output voltage V_{O1} of the power converter is connected to the load through an output cable 70, the output connector etc. The output cable 70, the output connector, etc. will cause the voltage drop that is proportional to its output current. Thus, remote-sense resistors 55, 56 and remote-sense cables 71, 72 are used for the remote sensing of the output voltage V_{O} at the load. This remote sensing is utilized to regulate the output voltage V_{O} at the load. Therefore, the output voltage V_{O} will be no impact to the voltage drop of the output cable 70 and the output connector, etc. However, the remote-sense cables 71 and 72 increase the cost of the power converter, particular when the output cable 70 is a long cable. Therefore, a regulation circuit with output cable compensation is needed for reducing the cost of the power converter and providing an accurate regulation for the output voltage V_{O}.

Refer to the technology of the output cable compensation for power converters, a prior art can be found in “Primary-side controlled switching regulator”, U.S. Pat. No. 7,352,595. However, this technology can only be applied to the primary side regulation. It means the error amplifier of the power converter must be located in the primary side of the transformer. The present invention provides a method and apparatus of the output cable compensation for an error amplifier located in the secondary side of the transformer.

### SUMMARY OF THE INVENTION

The object of the present invention is to provide a regulation circuit and a method with output cable compensation for the power converter. The regulation circuit and method compensate the voltage drop of the output cable of the power converter without the remote-sense cables for reducing the cost of the power converter and providing the accurate regulation for the output voltage.

The present invention provides the regulation circuit with an output cable compensation for the power converter. It includes an error amplifier generating a feedback signal in accordance with an output of the power converter. A compensation circuit is coupled to a transformer of the power converter for generating a compensation signal in response to a transformer signal generated by the transformer. The feedback signal is applied to generate a switching signal for switching the transformer and regulating the output of the power converter. The compensation signal is coupled to modulate the feedback signal for compensating the voltage drop of the output cable, the output connector, etc. of the power converter.

Further, the error amplifier includes a reference signal for generating the feedback signal. The compensation signal is coupled to compensate the reference signal for modulating the feedback signal. The regulation circuit further includes a resistor coupled to the compensation circuit for programming the level of the compensation signal. The transformer signal is related to an on time of the switching signal and the level of an input voltage of the transformer. The compensation signal is thus generated in accordance with a demagnetizing time of the transformer. Therefore, the compensation signal is increased in response to the increase of an output current of the power converter. The feedback signal is increased in response to the increase of the compensation signal. Because an output voltage of the power converter is increased in response to the increase of the feedback signal, the output voltage can be increased in response to the increase of the output current for the output cable compensation.

A method for compensating the output cable of the power converter according to the present invention comprises generating a feedback signal in accordance with an output of the power converter; generating a compensation signal in response to a transformer signal generated by a transformer of the power converter; and modulating the feedback signal by using the compensation signal. The feedback signal is utilized to generate a switching signal for switching the transformer of the power converter and regulating the output of the power converter. The compensation signal is coupled to compensate a voltage drop of the output cable of the power converter.

### BRIEF DESCRIPTION OF THE DRAWINGS

FIG. 1 illustrates a prior art circuit schematic of a power converter.

FIG. 2 is a circuit diagram of an embodiment of a power converter according to the present invention.

FIG. 3 is a circuit diagram of an embodiment of a regulation circuit with output cable compensation according to the present invention.

FIG. 4 is a circuit diagram of an embodiment of a compensation circuit for generating a compensation signal according to the present invention.

FIG. 5 shows a reference circuit of a voltage-to-current converter according to the present invention.

FIG. 6 shows signal waveforms of an on-time signal S_{ON}, a sample signal S₁ and a clear signal S₂ according to the present invention.

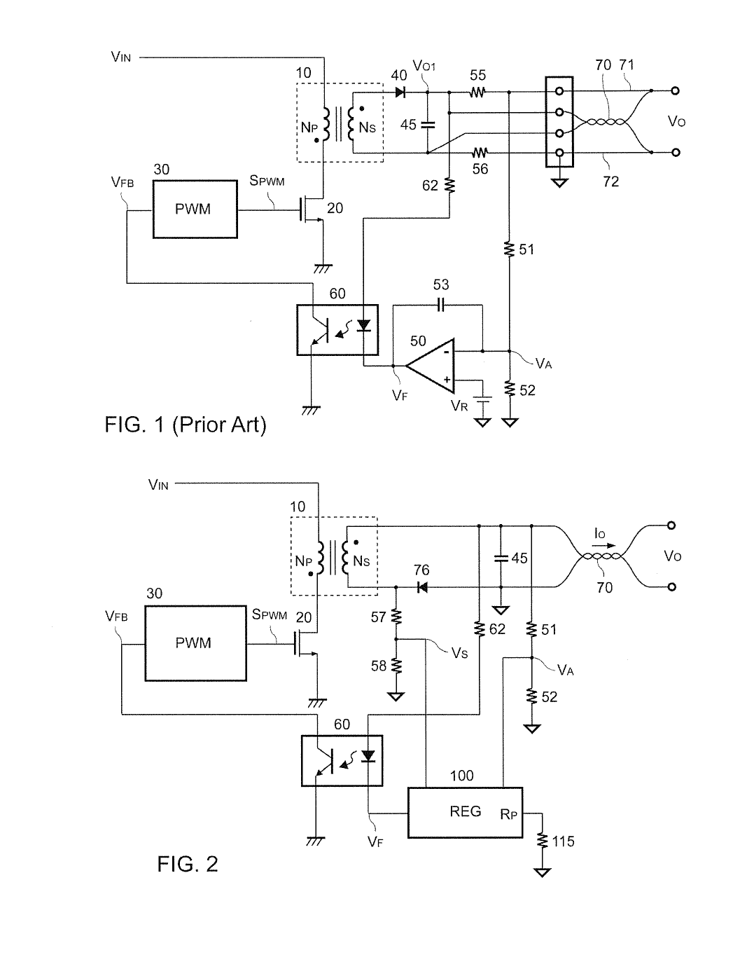

### DETAILED DESCRIPTION OF THE EMBODIMENTS

FIG. 2 is a circuit diagram of an embodiment of a power converter according to the present invention. The power converter comprises the transformer 10, the power transistor 20, the PWM controller (PWM) 30, and the opto-coupler 60. The power transistor 20 is coupled from the primary winding N_{P} of the transformer 10 to the ground for switching the transformer 10. The opto-coupler 60 is coupled to the secondary winding N_{S} of the transformer 10 through the resistor 62. The secondary winding N_{S} is coupled to the output terminal of the power converter to provide the output voltage V_{O} for the load through the output cable 70. The output current I_{O} of the power converter flows through the output cable 70. The output capacitor 45 is coupled to the secondary winding N_{S} and the output terminal of the power converter. The power converter has a diode 76 for rectification. The diode 76 is coupled from the output terminal of the power converter to the secondary winding N_{S}.

The power converter further includes a regulation circuit (REG) 100 for generating a first feedback signal V_{F}. The regulation circuit 100 is located in the secondary side of the transformer 10. The regulation circuit 100 is coupled to the output terminal of the power converter via the voltage divider developed by the resistors 51 and 52. The voltage divider generates a voltage V_{A} coupled to the regulation circuit 100. A resistor 115 is coupled to a terminal R_{P} of the regulation circuit 100 to determine the ratio of signal generation.

The first feedback signal V_{F} is further coupled to generate the second feedback signal V_{FB} through the opto-coupler 60. The PWM controller 30 generates the switching signal S_{PWM} to switch the transformer 10 via the power transistor 20 in accordance with the feedback signal V_{FB} for regulating the output (the output voltage V_{O} and/or the output current I_{O}) of the power converter. Therefore, the feedback signal V_{F} is applied to generate the switching signal S_{PWM} for switching the transformer 10 and regulating the output of the power converter. The feedback signals V_{F} and V_{FB} are generated in accordance with the output (the output voltage V_{O} and/or the output current I_{O}) of the power converter. The feedback signal V_{FB} is increased in response to the increase of the output current I_{O}. Because the output voltage V_{O} is increased in response to the increase of the feedback signal V_{FB}, the output voltage V_{O} can be increased in response to the increase of the output current I_{O} for the output cable compensation.

However, if we use a resistance device to sense the output current I_{O}, then this resistance device will result a power loss and cause lower power efficiency for the power converter. Therefore, the regulation circuit 100 is developed and coupled to the transformer 10 for detecting a transformer signal through a voltage divider developed by resistors 57 and 58. The transformer signal is generated by the transformer 10. A first terminal of the resistor 57 is coupled to the secondary winding N_{S} and the diode 76. The resistor 58 is coupled from a second terminal of the resistor 57 to a ground. The ground is located in the secondary side of the transformer 10. The resistors 57 and 58 produce a sense signal V_{S}. The sense signal V_{S} is related to the transformer signal. The transformer signal can be utilized to estimate the level of the output current I_{O}. The transformer signal is related to the level of the input voltage V_{IN} of the transformer 10 and the on time T_{ON} of the switching signal S_{PWM}.

$${T}_{discharge} = \frac{{V}_{M}}{{V}_{O}} \times {T}_{charge} \qquad ( 1 )$$

where the T-charge is the magnetizing time of the transformer 10; the T-charge is thus equal to the on time T_{ON} of the switching signal S_{PWM}; T-discharge is the demagnetizing time of the transformer 10. The V_{M} is the magnetizing voltage that is correlated to the input voltage V_{IN} of the transformer 10.

Thus, the equation (1) can be rewritten as equation (2),

$${T}_{discharge} = \frac{K \times {V}_{IN}}{{V}_{O}} \times {T}_{ON} \qquad ( 2 )$$

where K is a constant.

Refer to an output power P_{O} of the flyback power converter, it can be expressed as,

$${P}_{O} = {V}_{O \times } {I}_{O} = \frac{{V}_{IN}^{2} \times {T}_{ON}^{2}}{2 \times {L}_{P} \times T} \qquad ( 3 )$$

where L_{P} is the inductance of the primary winding N_{P} of the transformer 10; T is the switching period of the switching signal S_{PWM}.

In accordance with the equations (2) and (3), if the output voltage V_{O} is a fixed value, then the demagnetizing time T-discharge and the output current I_{O} are correlated to “the input voltage V_{IN} of the transformer 10” and “the on time T_{ON} of the switching signal S_{PWM}”. Therefore, the input voltage V_{IN} of the transformer 10 and the on time T_{ON} of the switching signal S_{PWM} can be used instead of the output current I_{O} to control the output voltage V_{O} for the output cable compensation.

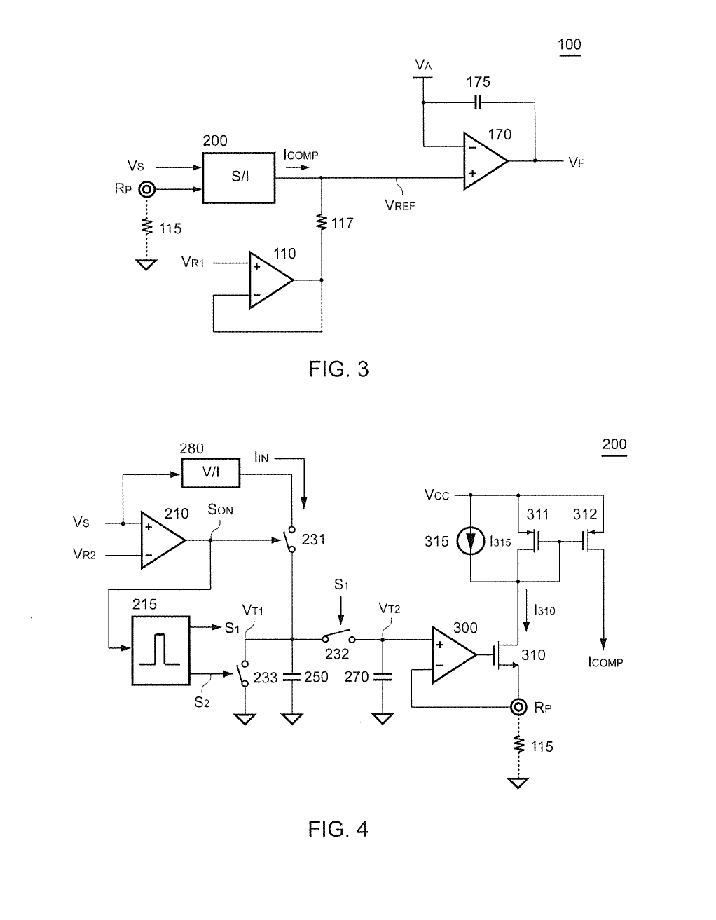

FIG. 3 is a circuit diagram of an embodiment of the regulation circuit 100 according to the present invention. It includes a compensation circuit (S/I) 200 that is coupled to the secondary winding N_{S} of the transformer 10 (as shown in FIG. 2) to receive the sense signal V_{S} for generating a compensation signal I_{COMP} in accordance with the sense signal V_{S}. The compensation signal I_{COMP} is generated in the secondary side of the transformer 10. The sense signal V_{S} is correlated to the input voltage V_{IN} of the transformer 10 and the on time of the switching signal S_{PWM} (as shown in FIG. 2). As mentioned above, the demagnetizing time of the transformer 10 and the output current I_{O} are correlated to the input voltage V_{IN} of the transformer 10 and the on time of the switching signal S_{PWM}, and therefore the compensation signal I_{COMP} is generated in accordance with the demagnetizing time of the transformer 10.

The resistor 115 is coupled to the compensation circuit 200 via the terminal R_{P} to determine the ratio of signal generation. The resistor 115 is used for programming the level of the compensation signal I_{COMP}. The compensation signal I_{COMP} generates a compensation voltage at a resistor 117. A reference voltage V_{R1} is connected in serial with the resistor 117 via a buffer amplifier 110. The reference voltage V_{R1} is supplied with a positive input terminal of the buffer amplifier 110. The resistor 117 is coupled from an output terminal of the compensation circuit 200 to an output terminal of the buffer amplifier 110. A negative input terminal of the buffer amplifier 110 is coupled to the output terminal of the buffer amplifier 110 and the resistor 117. The reference voltage V_{R1} associates with the compensation voltage at the resistor 117 to generate a reference signal V_{REF} for the error amplifier 170. The reference signal V_{REF} can be expressed as,

V_{REF}=V_{R1}+(I_{COMP}×R₁₁₇) (4)

According to equation (4), the reference signal V_{REF} is correlated to the compensation signal I_{COMP}. Therefore, the reference signal V_{REF} can be programmed and compensated by the compensation signal I_{COMP}. The reference signal V_{REF} can be programmed in response to the input voltage V_{IN} of the transformer 10 and the on time of the switching signal S_{PWM} (as shown in FIG. 2) due to the compensation signal I_{COMP} is correlated to the sense signal V_{S}, and the sense signal V_{S} is correlated to the input voltage V_{IN} of the transformer 10 and the on time of the switching signal S_{PWM}. Further, according to equation (4), the reference signal V_{REF} is further correlated to the reference voltage V_{R1} of the buffer amplifier 110. Therefore, the buffer amplifier 110 is coupled to the compensation signal I_{COMP} for generating the reference signal V_{REF}.

A capacitor 175 is used for the frequency compensation of the feedback loop of the power converter. The voltage V_{A} is generated from the output voltage V_{O} through the resistors 51 and 52 (as shown in FIG. 2). The error amplifier 170 is coupled to receive the reference signal V_{REF} and the voltage V_{A} to generate the feedback signal V_{F}. That is, the error amplifier 170 generates the feedback signal V_{F} in accordance with the output of the power converter and the reference signal V_{REF} for generating the feedback signal V_{FB} (as shown in FIG. 2). Accordingly, the feedback signal V_{F} is related to the output voltage V_{O}. The feedback signal V_{F} is modulated in response to the change of the compensation signal I_{COMP} because the compensation signal I_{COMP} is used to compensate the reference signal V_{REF}. In other words, the compensation signal I_{COMP} is coupled to modulate the feedback signal V_{F} for compensating the voltage drop of the output cable 70 (as shown in FIG. 2) of the power converter. A positive input terminal and a negative input terminal of the error amplifier 170 receive the reference signal V_{REF} and the voltage V_{A}, respectively. An output terminal of the error amplifier 170 generates the feedback signal V_{F}. The capacitor 175 is coupled between the negative input terminal of the error amplifier 170 and the output terminal of the error amplifier 170.

FIG. 4 is a circuit diagram of an embodiment of the compensation circuit 200 according to the present invention. The sense signal V_{S} is coupled to a voltage-to-current converter (V/I) 280 to generate a charging current I_{IN} in accordance with the level (amplitude) of the sense signal V_{S}. The charging current I_{IN} is correlated to the level of the input voltage V_{IN} of the transformer 10 (as shown in FIG. 2). The sense signal V_{S} is further coupled to a comparator 210 to generate an on-time signal S_{ON} when the level of the sense signal V_{S} is higher than a threshold V_{R2}. The on-time signal S_{ON} is related to the on time T_{ON} of the switching signal S_{PWM} (as shown in FIG. 2). A positive input terminal and a negative input terminal of the comparator 210 receive the sense signal V_{S} and the threshold V_{R2}, respectively. An output terminal of the comparator 210 outputs the on-time signal S_{ON}.

Through a switch 231, the charging current I_{IN} is coupled to charge a capacitor 250 for generating a signal V_{T1}. The signal V_{T1} is a voltage and utilized to generate the compensation signal I_{COMP}. The on/off of the switch 231 is controlled by the on-time signal S_{ON}. Therefore, the charging current I_{IN} charges the capacitor 250 in response to the sense signal V_{S} for generating the signal V_{T1}. The on-time signal S_{ON} is further coupled to a pulse generator 215 for generating a sample signal S₁ and a clear signal S₂. The waveforms of the on-time signal S_{ON}, the sample signal S₁ and the clear signal S₂ are shown in FIG. 6. The sample signal S₁ is enabled when the on-time signal S_{ON} is disabled. Once the sample signal S₁ is disabled, the clear signal S₂ is enabled after a delay time. The clear signal S₂ is applied to enable a switch 233 coupled between the capacitor 250 and the ground for discharging the capacitor 250.

A switch 232 is coupled between the capacitor 250 and a capacitor 270. The sample signal S₁ is utilized to enable the switch 232 for sampling the signal V_{T1} to the capacitor 270. Thus, the capacitor 270 produces a signal V_{T2}. Because the signal V_{T1} is generated in accordance with the charging current I_{IN} and the period of on-time signal S_{ON}, the level of the signals V_{T1} and V_{T2} are correlated to “the level of the input voltage V_{IN} of the transformer 10” and “the period of the on time T_{ON} of the switching signal S_{PWM}”.

The signal V_{T2} is coupled to an operational amplifier 300. The operational amplifier 300, the resistor 115, transistors 310, 311, and 312 develop a voltage-to-current converter for converting the signal V₇₂ to the compensation signal I_{COMP}. The capacitor 270 is coupled to a positive input terminal of the operational amplifier 300. A negative input terminal of the operational amplifier 300 is coupled to a source of the transistor 310 and the resistor 115 through the terminal R_{P}. The source of the transistor 310 is coupled to the resistor 115 through the terminal R_{P}. A gate of the transistor 310 is controlled by an output terminal of the operational amplifier 300. A current I₃₁₀ is generated at a drain of the transistor 310 in response to the signal V_{T2}. The current I₃₁₀ is further coupled to a current mirror formed by the transistors 311 and 312. The current mirror generates the compensation signal I_{COMP}. Sources of the transistors 311 and 312 are coupled to a supply voltage V_{CC}. Gates of the transistors 311 and 312 and drains of the transistors 310 and 311 are coupled together. A drain of the transistor 312 generates the compensation signal I_{COMP}.

The resistor 115 is used for programming the level of the compensation signal I_{COMP}. A current source 315 is connected between the supply voltage V_{CC} and the drain of the transistor 310 for providing an offset current I₃₁₅. Therefore, the signal V_{T2} must be higher than a specific value for generating the compensation signal I_{COMP}. This specific value is related to the offset current I₃₁₅.

The compensation signal I_{COMP} is generated in accordance with the demagnetizing time (T-discharge) of the transformer 10 (as shown in FIG. 2), which is shown in equations (1) and (2). Therefore, the compensation signal I_{COMP} is increased in response to the increase of the output current I_{O} of the power converter. The compensation signal I_{COMP} is coupled to compensate the reference signal V_{REF} for modulating the feedback signals V_{F} and V_{FB} (as shown in FIG. 2 and FIG. 3). The feedback signal V_{FB} is thus increased in response to the increase of the compensation signal I_{COMP}. Because the output voltage V_{O} is increased in response to the increase of the feedback signal V_{FB}, the output voltage V_{O} can be increased in response to the increase of the output current I_{O} for the output cable compensation.

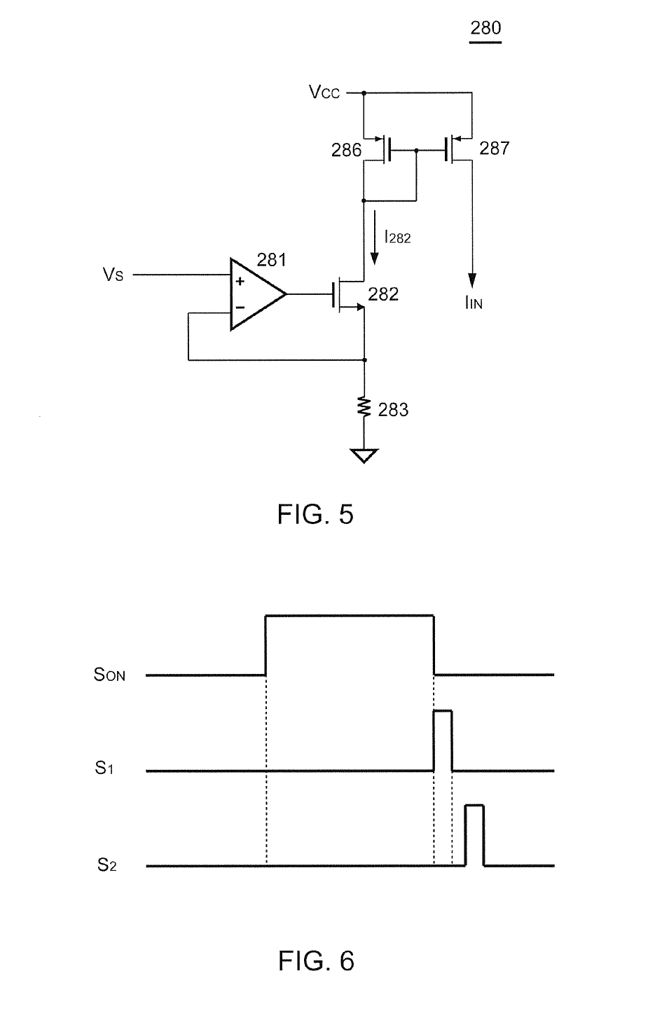

FIG. 5 shows a reference circuit of the voltage-to-current converter 280 according to the present invention. The voltage-to-current converter 280 comprises an operational amplifier 281, a transistor 282, a resistor 283 and a current mirror developed by transistors 286 and 287. A positive input terminal of the operational amplifier 281 receives the sense signal V_{S}. A negative input terminal of the operational amplifier 281 is coupled to a source of the transistor 282. An output terminal of the operational amplifier 281 is coupled to a gate of the transistor 282. The resistor 283 is coupled between the negative input terminal of the operational amplifier 281 and the ground. A current I₂₈₂ is generated at a drain of the transistor 282. A drain of the transistor 286 is coupled to receive the current I₂₈₂. Gates of the transistors 286 and 287 are coupled each other and they all are coupled to the drains of the transistors 286 and 282. Sources of the transistors 286 and 287 are coupled to the supply voltage V_{CC}. The charging current I_{IN} is generated at a drain of the transistor 287 in response to the current I₂₈₂.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A regulation circuit of a power converter, comprising:
an error amplifier generating a feedback signal in accordance with an output of the power converter; and
a compensation circuit coupled to a transformer of the power converter for generating a compensation signal in response to a transformer signal generated by the transformer;
wherein the feedback signal is applied to generate a switching signal for switching the transformer and regulating the output of the power converter; the compensation signal is coupled to modulate the feedback signal for compensating a voltage drop of an output cable of the power converter.

2. The regulation circuit as claimed in claim 1, wherein the error amplifier comprises a reference signal for generating the feedback signal; the compensation signal is coupled to compensate the reference signal for modulating the feedback signal.

3. The regulation circuit as claimed in claim 1, further comprising:
a resistor coupled to the compensation circuit for programming the level of the compensation signal.

4. The regulation circuit as claimed in claim 1, wherein the transformer signal is related to an on time of the switching signal and the level of an input voltage of the transformer.

5. The regulation circuit as claimed in claim 1, wherein the compensation signal is generated in accordance with a demagnetizing time of the transformer.

6. The regulation circuit as claimed in claim 1, wherein the compensation signal is increased in response to the increase of an output current of the power converter; the feedback signal is increased in response to the increase of the compensation signal; an output voltage is increased in response to the increase of the feedback signal.

7. The regulation circuit as claimed in claim 1, wherein the regulation circuit is located in a secondary side of the transformer.

8. The regulation circuit as claimed in claim 1, wherein the compensation circuit comprises:
a capacitor providing a voltage for generating the compensation signal;
a charging current charging the capacitor in response to the transformer signal for providing the voltage, the charging current is correlated to the transformer signal; and
a voltage to current converter converting the voltage to the compensation signal;
wherein the transformer signal is related to an on time of the switching signal and the level of an input voltage of the transformer.

9. A method for compensating an output cable of a power converter, comprising:
generating a feedback signal in accordance with an output of the power converter;
generating a compensation signal in response to a transformer signal generated by a transformer of the power converter; and
modulating the feedback signal by using the compensation signal;
wherein the feedback signal is utilized to generate a switching signal for switching the transformer of the power converter and regulating the output of the power converter; the compensation signal is coupled to compensate a voltage drop of the output cable of the power converter.

10. The method as claimed in claim 9, wherein the feedback signal is generated by an error amplifier; the error amplifier further comprises a reference signal for generating the feedback signal; the compensation signal is coupled to compensate the reference signal for modulating the feedback signal.

11. The method as claimed in claim 9, further comprising:
programming the level of the compensation signal by a resistor.

12. The method as claimed in claim 9, wherein the transformer signal is related to an on time of the switching signal and the level of an input voltage of the transformer.

13. The method as claimed in claim 9, wherein the compensation signal is generated in accordance with a demagnetizing time of the transformer.

14. The method as claimed in claim 9, wherein the compensation signal is generated in a secondary side of the transformer.

15. A regulation circuit of a power converter, comprising:
a compensation circuit coupled to modulate a feedback signal in response to a transformer signal generated by a transformer of the power converter;
wherein the feedback signal is applied to generate a switching signal for switching the transformer and regulating an output of the power converter; the transformer signal is related to an on time of the switching signal and the level of an input voltage of the transformer; the feedback signal is related to an output voltage of the power converter; the output voltage is increased in response to the increase of an output current of the power converter for compensating a voltage drop of an output cable of the power converter.

16. The regulation circuit as claimed in claim 15, wherein the regulation circuit is located in a secondary side of the transformer.
